(19) United States
(12) Patent Application Publication
(10) Pub. No.: US 2014/0299728 A1
(43) Pub. Date: Oct. 9, 2014

(54) MINIATURE QUIVER

(71) Applicant: David Thomas Sparks, Nevada, MO (US)

(72) Inventor: David Thomas Sparks, Nevada, MO (US)

(21) Appl. No.: 13/856,023

(22) Filed: Apr. 3, 2013

(51) Int. Cl. F16M 13/02

(52) U.S. Cl. CPC F16M 13/02
USPC 248/231.91

(57) ABSTRACT

A miniature quiver may hold at least one arrow. The miniature quiver may include a retractable and deployable screw. The screw may be screwed into a tree so that the miniature quiver may be placed in an easy to reach position so that a hunter may grab an arrow from the miniature quiver in a short amount of time.

### BACKGROUND OF THE INVENTION

The present invention relates to a miniature quiver and, more particularly, to a miniature quiver that may be attached to a tree.

Throughout the hunting season, a hunter may use a plurality of devices to facilitate their hunting experience. Depending on the time of the year and the game being hunted, a hunter may use shotgun, rifle, handgun, or bow-and-arrow. For those hunters that prefer to bow hunt, it is very common for the hunter to use a tree stand or the tree in general as a means of remaining undetected from the game in which they are pursuing.

Although a tree serves a vital role for hunters in remaining undetected from the game they are pursuing, a tree unfortunately does not provide sufficient storage or convenience to the hunters. Hunters tend to suspend their equipment from the tree's branches, which is inefficient, inconvenient, and unsafe. Depending on the tree, the hunter may have to climb higher to store their equipment, which may ultimately lead to the hunter slipping and falling off the tree. In addition, the hunter's equipment may be caught, tangled, or snagged on the tree itself, which could then lead to burdensome delays in the hunting process.

Furthermore, in the event the hunter misses the targeted game, the hunter may then have to travel to the area of the tree where his equipment is being stored, ultimately leading to the hunter losing his opportunity to immobilize the targeted game. Therefore, it is desirable to have a device or piece of equipment that is capable to rectifying these problems and issues faced by hunters.

As can be seen, there is a need for a portable and safe quiver for storing extra arrows.

### SUMMARY OF THE INVENTION

In one aspect of the present invention, a miniature quiver comprising: a base comprising a first ridge and a second ridge, wherein the first ridge and the second ridge form a channel configured to secure at least one arrow; and a screw comprising a tip, wherein the screw is connected to the base, wherein the screw is in a retracted position and a deployed position, wherein the retracted position comprises the tip adjacent to the base and the deployed position comprises the screw protruding from the base.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention shown in a retracted position;

FIG. 3 is a perspective view of the present invention shown in a deployed position;

FIG. 4 is a side view of the present invention shown in a retracted position;

FIG. 5 is a side view of the present invention shown in a deployed position;

FIG. 6 is a top view of the present invention shown in a deployed position;

FIG. 7 is a section detailed view of the present invention along line 7-7 in FIG. 1;

FIG. 8 is a perspective view of an alternate embodiment of the present invention shown in use;

FIG. 9 is a perspective view of an alternate embodiment of the present invention shown in a retracted position;

FIG. 10 is a perspective view of an alternate embodiment of the present invention shown in a deployed position;

FIG. 11 is a front view of an alternate embodiment of the present invention shown in a deployed position;

FIG. 12 is a side view of an alternate embodiment of the present invention shown in a retracted position;

FIG. 13 is a top view of an alternate embodiment of the present invention shown in a deployed position; and

FIG. 14 is a sectional detailed view of the present invention along line 14-14 in FIG. 8.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a miniature quiver for holding at least one arrow. The miniature quiver may include a retractable and deployable screw. The screw may be screwed into a tree so that the miniature quiver may be placed in an easy to reach position so that a hunter may grab an arrow from the miniature quiver in a short amount of time.

The present invention may include a small and portable quiver that may facilitate a second chance opportunity while hunting in a tree stand. In certain embodiments, the present invention may include a retractable screw which may allow for a compact and safe design. The quiver of the present invention secures an arrow in a desired location so that a hunter may access a spare arrow in a time of need. The mini-quiver housing cradles the arrow on one end securing it, and houses the retractable T-screw on the other end. When the T-screw is deployed it can be screwed into the tree at a specific location. When retracted it may fit safely inside the mini-quivers housing for safety and portability during transport.

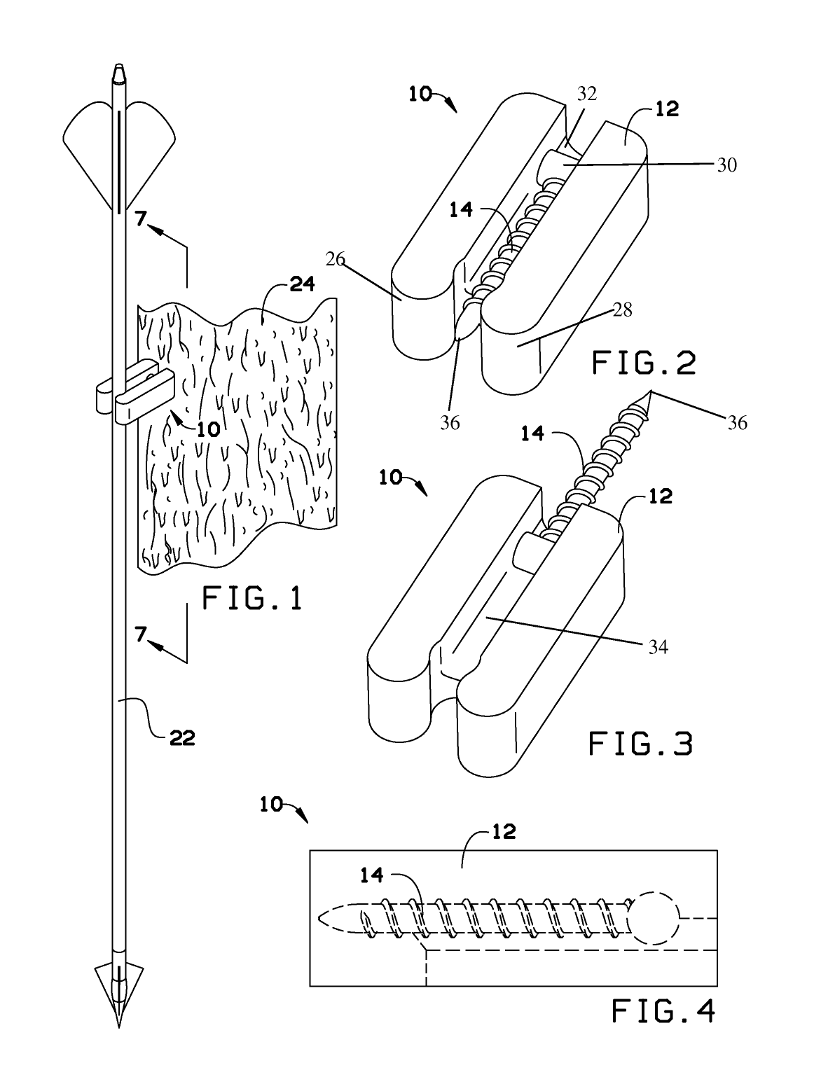

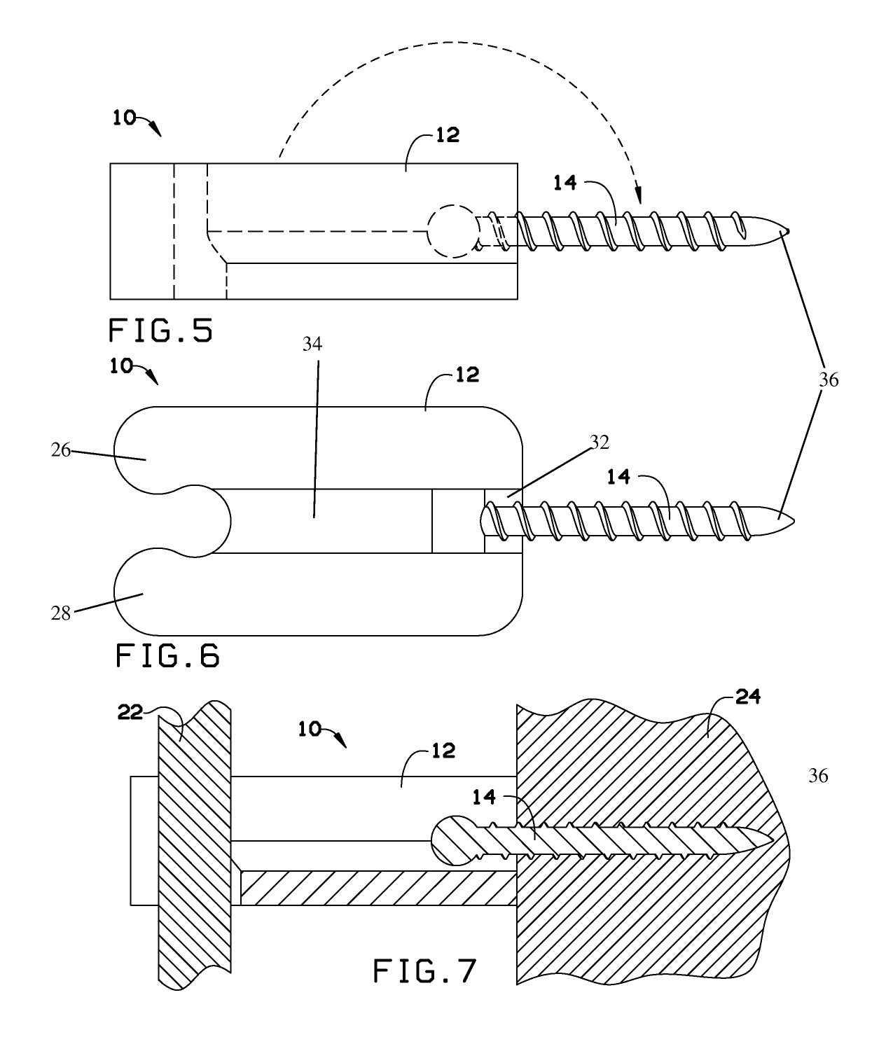

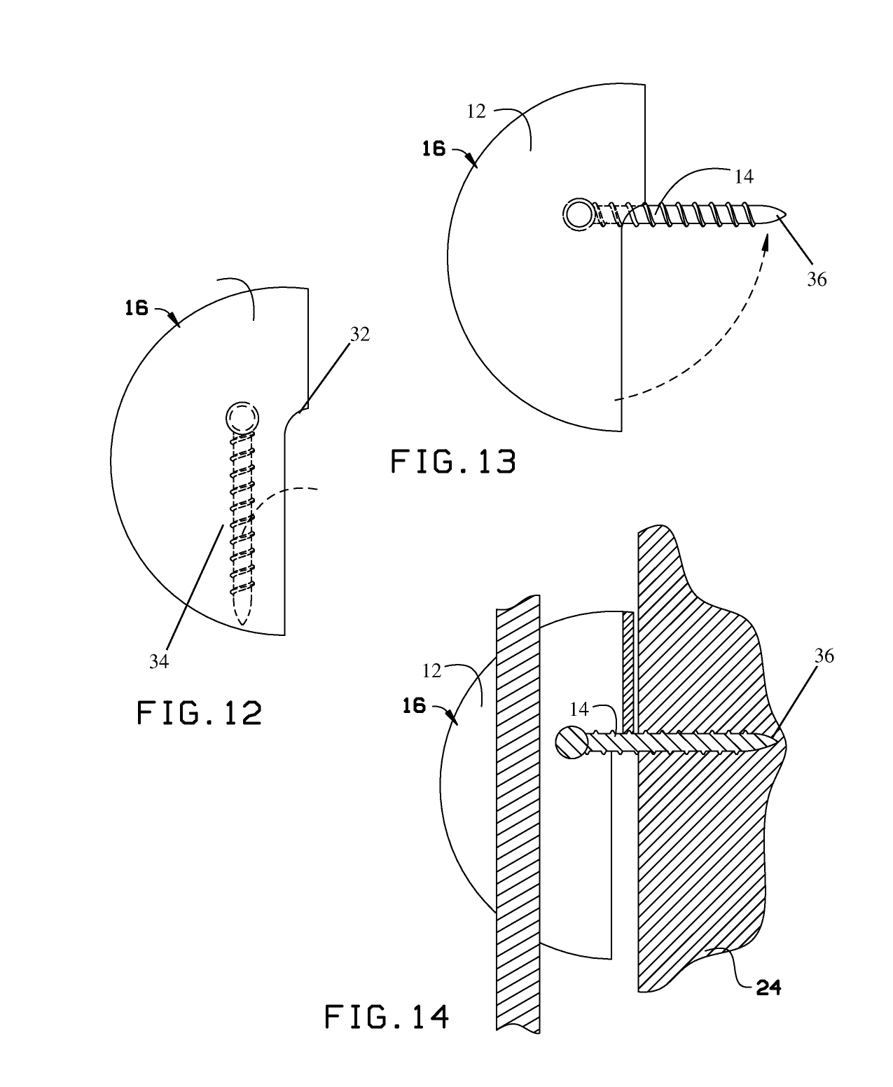

Referring to FIGS. 1 through 14, the present invention may include a quiver 10, 16. The quiver 10, 16 may include a base 12. The base 12 may include a first ridge 26 and a second ridge 28. The first ridge 26 and the second ridge 28 may form a channel in between. The channel may be sized and shaped to hold and retain at least one arrow 22. In certain embodiments, the channel may retain multiple arrows 22 and in certain embodiments, the base 12 may include multiple channels for multiple arrows 22.

The present invention may further include a screw 14 which may include a screw tip 36. The screw 14 may be attached to the base 12 of the quiver 10, 16. In certain embodiments, the screw 14 may be in a retracted position and a deployed position. In the retracted position, the screw tip 36 may be adjacent to the body 12. In the deployed position, the screw tip 36 may be protruding from the body 12.

In certain embodiments, the screw 14 may be connected to the base 12 by a swivel 30. The swivel 30 allows the screw 14 to rotate relative to the base 12. The swivel 30 may allow the screw 14 to transition from the retracted position to the deployed position. However, it is envisioned that the screw 14 may transition from the retracted position to the deployed position using other mechanisms. For example, the screw 30 may be deployed from the base via a linear actuating mechanism.

In certain embodiments, the present invention may include a screw housing 34. The screw housing 34 may be within the base 12 and may include a pair of ridges with a channel in between, in which the screw 14 may fit in the channel and may be housed in the retracted position. The screw housing 24 may further include a back stop 32. Therefore, when the screw 14 is deployed from the screw housing 34, the screw 14 may be stopped from further rotating by the back stop 32 and may rest against the back stop 32 in the deployed position.

The present invention may include multiple configurations. Examples of the multiple configurations are presented in the Figures. FIGS. 1 through 7 provide an exemplary embodiment of quiver 10. The screw housing 34 of quiver 10 may be substantially perpendicular to the channel. In the retracted position, the screw 14 may be substantially within the screw housing 18. In a deployed position, the screw 14 may rotate around 180 degrees and protrude from the base 12. The screw 14 may rest on the backstop 32

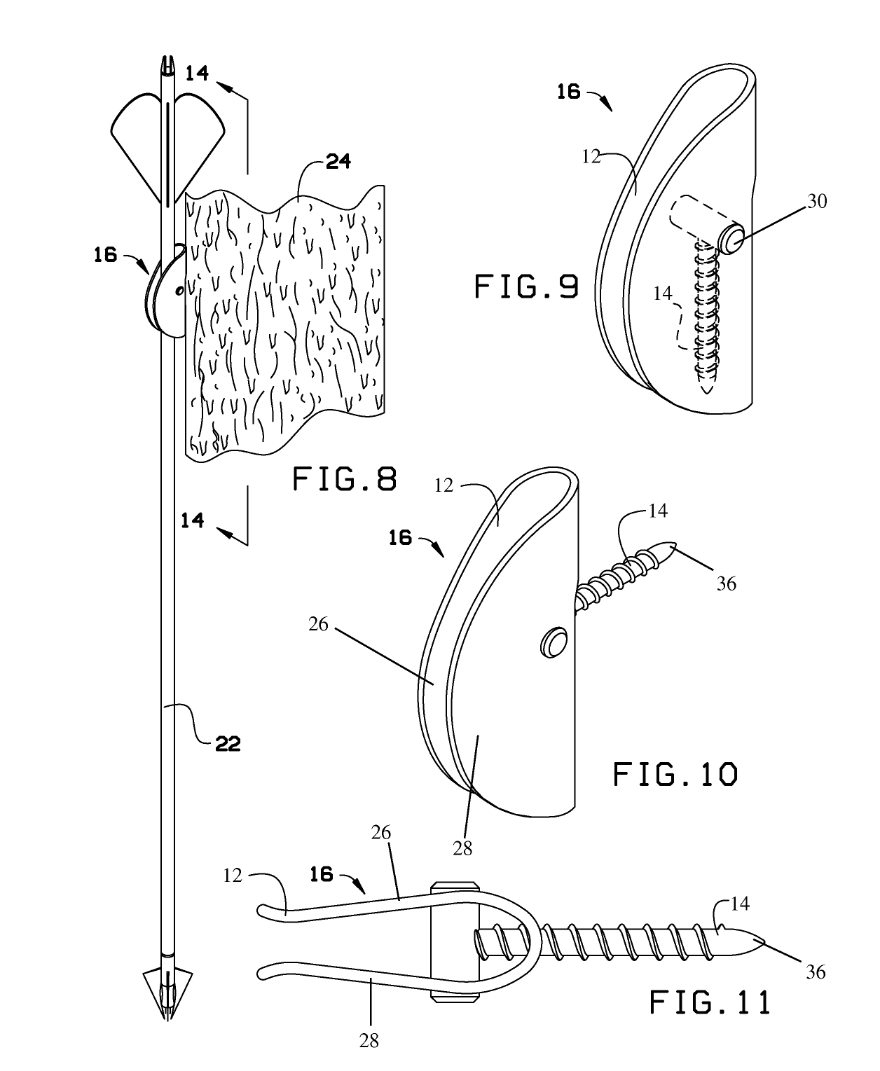

FIGS. 8 through 14 provide an exemplary embodiment of quiver 16. The screw housing 34 of quiver 16 may be substantially parallel to the channel. In the retracted position, the screw 14 may be substantially within the screw housing 34. In a deployed position, the screw 14 may rotate around 90 degrees and protrude from the base 12. The screw 14 may rest on the backstop 32.

An example of a method of using the present invention is disclosed below. The screw 14 may first be deployed from the retracted position to the deployed position. The screw 14 may be deployed manually, or by a spring loaded action. The user may then rotate the screw 14 into a tree 24 to secure the quiver 10, 16 to the tree 24. The user may then place an arrow 22 in between the first ridge 26 and the second ridge 28 and into the channel. The arrow is thereby secured to the tree in the desired location.

An example of a method of making the present invention is disclosed below. The body 12 of the quiver 10, 16 may be made by an injection mold or may be carved from a piece of material. A screw 14 may be attached to the body by a swivel and may rest within the screw housing 34. In certain embodiments, outside flanges may be folded over and glued down securing the screw in place. In certain embodiments, a camouflaged sticker may be placed over the body 12 of the mini-quiver. The mini-quiver body 12 may be made out of many different materials, such as, but not limited to, wood, metal, rubber, urethane, plastics and the like.

It should be understood, of course, that the foregoing relates to exemplary embodiments of the invention and that modifications may be made without departing from the spirit and scope of the invention as set forth in the following claims.

What is claimed is:

1. A mini-quiver comprising:
a base comprising a first ridge and a second ridge, wherein the first ridge and the second ridge form a channel configured to secure at least one arrow; and
a screw comprising a tip, wherein the screw is connected to the base,
wherein the screw is in a retracted position and a deployed position, wherein the retracted position comprises the tip of the screw adjacent to the base and the deployed position comprises the tip of the screw protruding from the base.

2. The mini-quiver of claim 1, wherein the screw is connected to the base by a swivel.

3. The mini-quiver of claim 2, wherein the screw rotates from about 90 degrees to about 180 degrees when transitioning from the retracted position to the deployed position.

4. The mini-quiver of claim 1, further comprising a screw housing, wherein the retracted position comprises the screw within the screw housing.

5. The mini-quiver of claim 4, wherein the screw housing comprises a backstop.
